(19) United States
(12) Patent Application Publication
(10) Pub. No.: US 2026/0177209 A1
(43) Pub. Date: Jun. 25, 2026

(54) CARRY HANDLE ASSEMBLY FOR PRESSURIZED GAS CYLINDER

(71) Applicant: Gadgets & Gizmos LLC, Downers Grove, IL (US)

(72) Inventor: Tyler Krapez, Downers Grove, IL (US)

(21) Appl. No.: 19/537,462

(22) Filed: Feb. 11, 2026

(51) Int. Cl. F17C 13/08

(52) U.S. Cl. CPC F17C 13/084; F17C 2201/0119; F17C 2205/0165; F17C 2205/0323; F17C 2205/0364; F17C 2221/011; F17C 2270/025

(57) ABSTRACT

A carry handle assembly for a pressurized gas cylinder includes a cylinder-attaching portion for encircling and attaching to an outer sidewall of a pressurized gas cylinder. The carry handle assembly further includes a friction clamp located on the cylinder-attaching portion for securing the cylinder-attaching portion to the pressurized gas cylinder. The carry handle assembly further includes a handle portion including a handle for lifting and carrying the pressurized gas cylinder.

### TECHNICAL FIELD

The subject matter described herein relates to facilitating lifting and transporting pressurized gas cylinders. More particularly, the subject matter described herein relates to a carry handle assembly for facilitating lifting and transporting of a pressurized gas cylinder, such as an acetylene tank.

### BACKGROUND

Pressurized gas cylinders, such as acetylene tanks, are difficult to lift and carry because they are heavy and lack structures suitable for manual carrying and transportation. Lifting and carrying the tank by the gas valve may be undesirable because doing so could inadvertently open or damage the valve. In addition, in many cases, hoses, a pressure gauge, and a torch are attached to the gas valve, making carrying the acetylene tank and all of its attached accessories cumbersome.

One existing carry handle includes a snap ring that fits in a groove in a nitrogen tank and in a corresponding groove in the carry handle. Such a carry handle can only be used with pressurized gas cylinders that include the groove for the snap ring and that exactly match the diameter of the snap ring. In addition, the carry handle lacks any feature for holding tank accessories, such as hoses, pressure gauges, and torches.

In light of these and other difficulties, there exists a need for an improved carry handle assembly that facilitates lifting and carrying of a pressurized gas cylinder.

### SUMMARY

A carry handle assembly for a pressurized gas cylinder, the carry handle assembly incudes a cylinder-attaching portion for encircling and attaching to an outer sidewall of a pressurized gas cylinder. The carry handle assembly further includes a friction clamp located on the cylinder-attaching portion for securing the cylinder-attaching portion to the pressurized gas cylinder. The carry handle assembly further includes a handle portion including a handle for lifting and carrying the pressurized gas cylinder.

According to another aspect of the subject matter described herein, the cylinder-attaching portion is adjustable in diameter using the friction clamp to securely attach to pressurized gas cylinders of different sizes.

According to another aspect of the subject matter described herein, the friction clamp comprises a bolt clamp.

According to another aspect of the subject matter described herein, the bolt clamp includes first and second tabs extending radially outward from the cylinder-attaching portion, each of the first and second tabs including an aperture for receiving a bolt.

According to another aspect of the subject matter described herein, the first and second tabs are circumferentially spaced from each other by a distance that causes a diameter of the cylinder-attaching portion to exceed a diameter of the pressurized gas cylinder.

According to another aspect of the subject matter described herein, the carry handle assembly includes a bolt insertable through the apertures and a corresponding nut for threaded attachment to the bolt to decrease the distance between the first and second tabs and tighten the cylinder-attaching portion around an outer circumference of the pressurized gas cylinder.

According to another aspect of the subject matter described herein, the carry handle assembly includes a sidewall and a first opening in the sidewall for accessing a gas valve of the pressurized gas cylinder.

According to another aspect of the subject matter described herein, the carry handle assembly includes a sidewall, wherein the handle portion forms a second opening in the sidewall.

According to another aspect of the subject matter described herein, the handle portion forms a second opening at an end of the carry handle assembly, and the handle extends diametrically across the end of the carry handle assembly.

According to another aspect of the subject matter described herein, the carry handle assembly includes a torch holder for holding a torch fed by gas from the pressurized gas cylinder.

According to another aspect of the subject matter described herein, the torch holder extends radially outward from the handle portion.

According to another aspect of the subject matter described herein, the carry handle assembly includes a hose shelf for holding a gas hose, wherein the torch holder comprises a notch formed in the hose shelf.

According to another aspect of the subject matter described herein, the carry handle assembly includes a sidewall, and the hose shelf forms an acute angle with respect to the sidewall.

According to another aspect of the subject matter described herein, the cylinder-attaching portion and the handle portion comprise a polypropylene material.

According to another aspect of the subject matter described herein, a method for lifting and carrying a pressurized gas cylinder is provided. The method includes placing a cylinder-attaching portion of a carry handle assembly around an outer sidewall of a pressurized gas cylinder. The method further includes tightening a friction clamp extending from the cylinder-attaching portion for securing the cylinder-attaching portion to the pressurized gas cylinder. The method further includes lifting the pressurized gas cylinder via a handle portion of the carry handle assembly by gripping a handle formed in the handle portion and exerting upward force on the handle to lift the pressurized gas cylinder.

According to another aspect of the subject matter described herein, tightening the friction clamp includes inserting a bolt through apertures in first and second tabs of the friction clamp, threading a nut onto the bolt, and tightening the nut to decrease a diameter of the cylinder-attaching portion.

According to another aspect of the subject matter described herein, the method includes inserting a torch attached to the pressurized gas cylinder into a torch holder formed in the carry handle assembly.

According to another aspect of the subject matter described herein, the method includes winding a gas hose attached to the pressurized gas cylinder around carry handle assembly and resting turns of the gas hose on a hose shelf extending radially outward from a sidewall of the carry handle assembly.

According to another aspect of the subject matter described herein, the method includes inserting the gas hose through a torch holder extending radially outward from the carry handle assembly.

According to another aspect of the subject matter described herein, the method includes inserting the gas hose through a torch holder comprising a notch formed by the hose shelf.

### BRIEF DESCRIPTION OF THE DRAWINGS

Exemplary implementations of the subject matter described herein will now be explained with reference to the accompanying drawings, of which:

FIG. 1 is a perspective view of a carry handle assembly for a pressurized gas cylinder;

FIG. 2 is an image of a side view of a carry handle assembly for a pressurized gas cylinder and a pressurized gas cylinder;

FIG. 3 is an image of a carry handle assembly for a pressurized gas cylinder and a pressurized gas cylinder from an opposite side of the view illustrated in FIG. 2;

FIG. 4 is an image of a top view of a carry handle assembly for a pressurized gas cylinder and a pressurized gas cylinder;

FIG. 5 is an image of a side view of a carry handle assembly for a pressurized gas cylinder and a pressurized gas cylinder illustrating a torch holder extending radially from the main body of the carry handle assembly;

FIG. 6 is an image of a side view of a carry handle assembly for a pressurized gas cylinder and a pressurized gas cylinder illustrating a hose shelf extending radially from the main body of the carry handle assembly;

FIG. 7 is a flow chart illustrating an exemplary process for lifting and carrying a pressurized gas cylinder;

FIGS. 8A and 8B illustrate an alternate design of a carry handle assembly for a pressurized gas cylinder;

FIG. 8C is a top view of the alternate design of the carry handle assembly for the pressurized gas cylinder illustrated in FIGS. 8A and 8B; and

FIG. 8D is a perspective view of the carry handle assembly for the pressurized gas cylinder illustrated in FIGS. 8A-8C with a gas hose resting on the hose shelf and the torch extending through one of the torch holder notches in the hose shelf.

### DETAILED DESCRIPTION

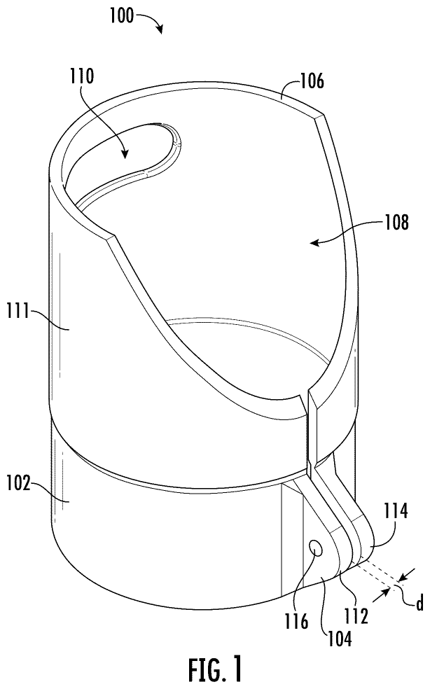

The subject matter described herein includes a carry handle assembly for a pressurized gas cylinder that facilitates lifting and transporting of the cylinder and that also includes a carry handle assembly for a torch or other accessory and a shelf to keep turns of a gas hose wound around the cylinder from slipping down the outer wall of the cylinder. FIG. 1 is a perspective view of a carry handle assembly for a pressurized gas cylinder. Referring to FIG. 1, a carry handle assembly 100 for a pressurized gas cylinder includes a cylinder-attaching portion 102 for encircling and attaching to an outer sidewall of a pressurized gas cylinder. Carry handle assembly 100 further includes a friction clamp 104 for securing cylinder-attaching portion 102 to the pressurized gas cylinder. Carry handle assembly 100 further includes
a handle portion 106 extending upwards from cylinder-attaching portion 102 and forming a first opening 108 for accessing a gas valve of the pressurized gas cylinder and a second opening 110 forming a carry handle for the pressurized gas cylinder. First opening 108 has a parabolic shape, and second opening 110 has a rectangular shape with rounded corners and is sized to allow a user's fingers to pass through second opening 110 for securely lifting and carrying carry handle assembly 100 and a pressurized gas cylinder to which carry handle assembly 100 is attached. In the example in FIG. 1, first opening 108 and second opening 110 are formed in a sidewall 111 of carry handle assembly 100.

Carry handle assembly 100 may be formed of any suitable material with sufficient load bearing strength to securely attach to and lift a pressurized gas cylinder. In one example, carry handle assembly 100 may be made of a polypropylene material.

In one example, cylinder-attaching portion 102 is adjustable in diameter to fit around pressurized gas cylinders of different sizes. The adjustment of the diameter of cylinder-attaching portion can be achieved using friction clamp 104, which, in the illustrated example, is a bolt clamp. Friction clamp 104 includes first and second tabs 112 and 114 extending radially outward from cylinder-attaching portion 102. Each of tabs 112 and 114 includes an aperture 116 for receiving a bolt. First and second tabs 112 and 114 are circumferentially spaced from each other by a distance d that causes a diameter of cylinder-attaching portion 102 to exceed a diameter of the pressurized gas cylinder. When a bold is inserted through apertures 116, and a nut is threaded onto the bolt and tightened, the distance between the first and second tabs 112 and 114 decreases to tighten the cylinder-attaching portion 102 around an outer circumference of the pressurized gas cylinder. In one example, the distance d may be decreased to zero such that facing surfaces of first and second tabs 112 and 114 are brought into contact with each other.

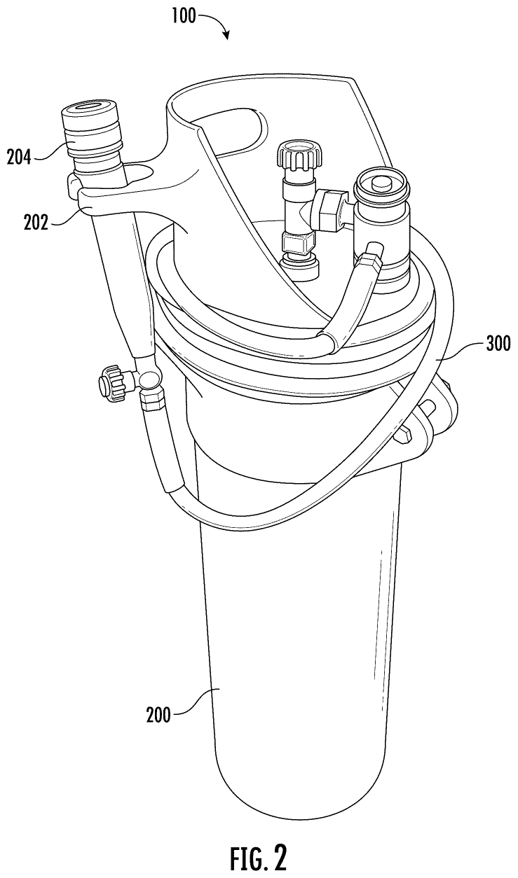

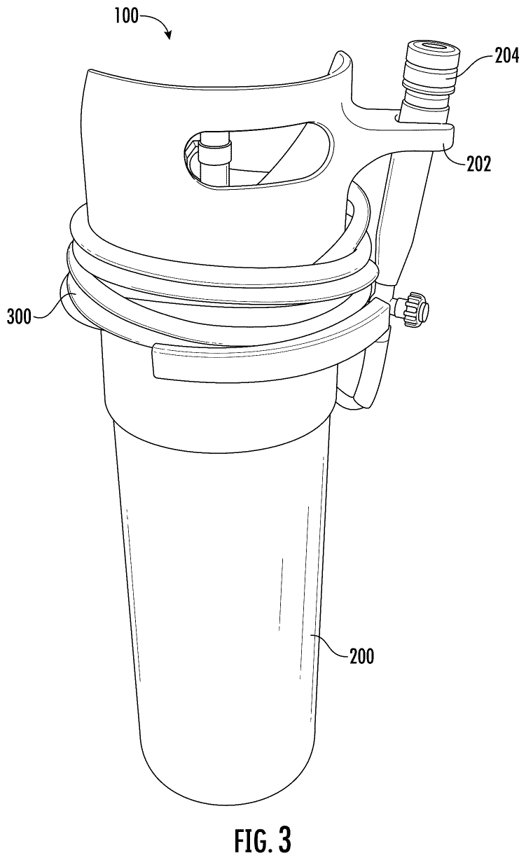

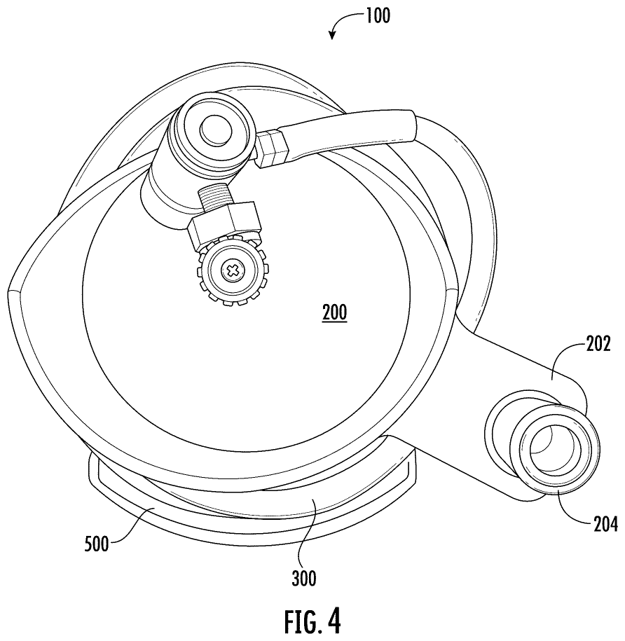

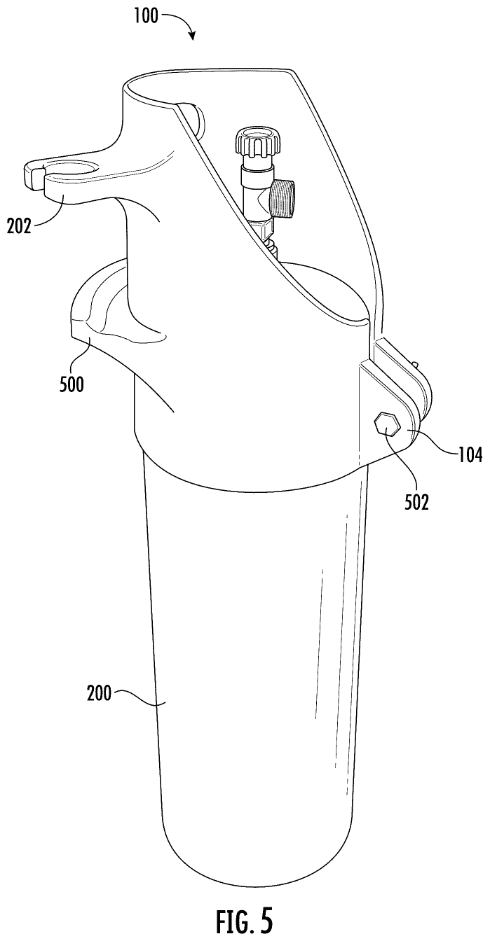

FIG. 2 is an image of a side view of a carry handle assembly for a pressurized gas cylinder and a pressurized gas cylinder. In FIG. 2, carry handle assembly 100 is attached to a pressurized gas cylinder 200, which, in the illustrated example, is an acetylene gas tank. Carry handle assembly 100 includes a torch holder 202 extending radially outward from handle portion 106 for holding a torch 204, such as an acetylene welding or cutting torch. As illustrated by the side views in FIGS. 2 and 3, the top view in FIG. 4, and the side view without the torch in FIG. 5, torch holder 202 forms a cylindrical opening having a diameter sized for frictional attachment to an outer circumference of torch 204.

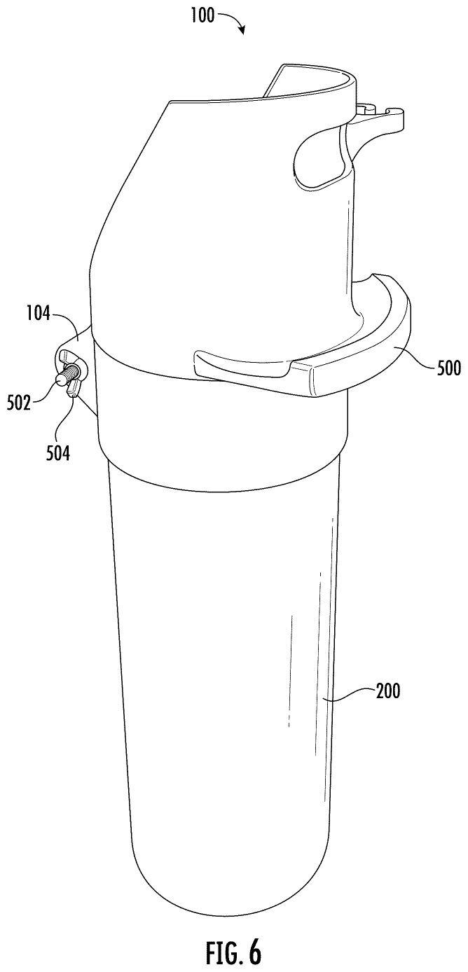

FIG. 3 is an image of a carry handle assembly for a pressurized gas cylinder and a pressurized gas cylinder from an opposite side of the view illustrated in FIG. 2. In FIG. 3, a gas hose 300 is wound around an outer circumference of pressurized gas cylinder 200. As illustrated most clearly in FIGS. 5 and 6, carry handle assembly 100 includes a hose shelf 500 extending radially outward from cylinder-attaching portion 102 for holding turns of hose 300 circumferentially wound around pressurized gas cylinder 200.

FIG. 4 is an image of a top view of a carry handle assembly for a pressurized gas cylinder and a pressurized gas cylinder. In FIG. 4, hose shelf 500 is shown as providing vertical support for hose 300.

FIG. 5 is an image of a side view of a carry handle assembly for a pressurized gas cylinder and a pressurized gas cylinder, illustrating torch holder 202 extending radially from the main body of carry handle assembly 100. FIG. 5 also illustrates a bolt 502 inserted into friction clamp 104 to decrease the inner diameter of cylinder-attaching portion 102 for secure frictional attachment to pressurized gas cylinder 200.

FIG. 6 is an image of a side view of carry handle assembly 100 and pressurized gas cylinder 200 illustrating hose shelf 500 extending radially outward from cylinder-attaching portion 102. FIG. 6 also illustrates nut 504 for threading onto bolt 502 to tighten friction clamp 104. In the illustrated example, nut 504 is a wing nut. However, other types of nuts can be used without departing from the scope of the subject matter described herein.

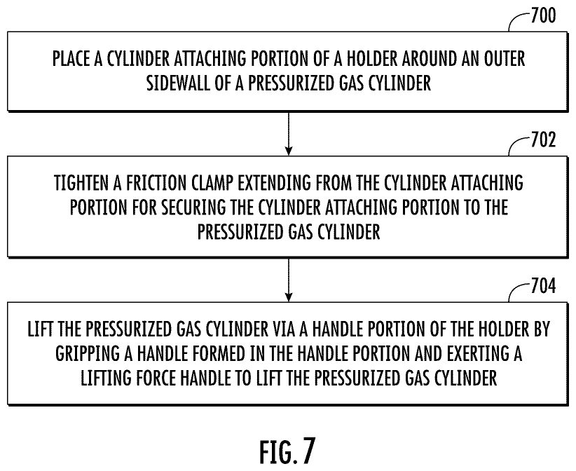

FIG. 7 is a flow chart illustrating an exemplary process for lifting and carrying a pressurized gas cylinder. Referring to FIG. 7, in step 700, the process includes placing a cylinder-attaching portion of a carry handle assembly around an outer sidewall of a pressurized gas cylinder. For example, a user may fit cylinder-attaching portion 102 of carry handle assembly 100 around an outer sidewall hear the top of pressurized gas cylinder 200.

In step 702, the process further includes tightening a friction clamp extending from the cylinder-attaching portion for securing the cylinder-attaching portion to the pressurized gas cylinder. For example, a user may insert a bolt into apertures 116 of friction clamp 104, thread a nut onto the bolt, and tighten the nut to securely attach cylinder-attaching portion 102 to the outer diameter of pressurized gas cylinder 200.

In step 704, the process further includes lifting the pressurized gas cylinder via a handle portion of the carry handle assembly by gripping a handle formed in the handle portion and exerting a lifting force on the handle on the handle to lift the pressurized gas cylinder. For example, a user may grip the handle formed by second opening 110 or handle 800 and lift upwards to lift and carry pressurized gas cylinder 200.

Thus, as illustrated, a carry handle assembly for a pressurized gas cylinder with a variable diameter using a friction clamp provides secure attachment to pressurized gas cylinders for lifting and transport and facilitates attachment to gas cylinders of varying diameters or circumferences, either due to differences in design or differences in pressure depending on whether the cylinders are full or not. The torch holder and the hose shelf allow a pressurized gas cylinder to be easily transported, even when a hose and a torch are attached to the cylinder.

While the examples described above illustrate carry handle assembly 100 being used to attach to an acetylene tank, the subject matter described herein is not limited to using carry handle assembly 100 to attach to an acetylene tank. Carry handle assembly 100 may be sized to attach to and used to carry any pressurized gas tank, including an industrial oxygen tank or a scuba tank without departing from the scope of the subject matter described herein.

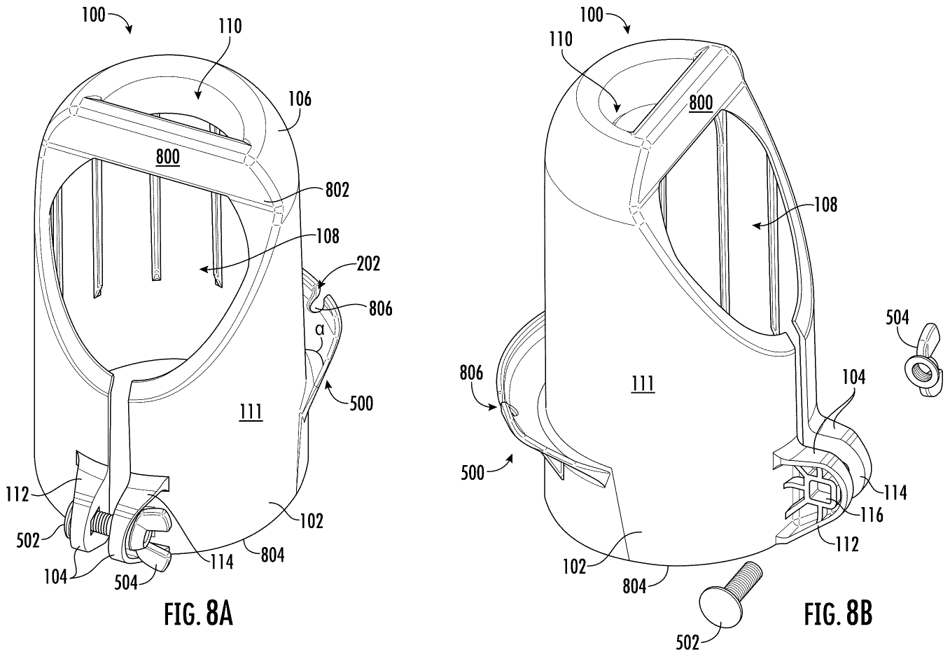

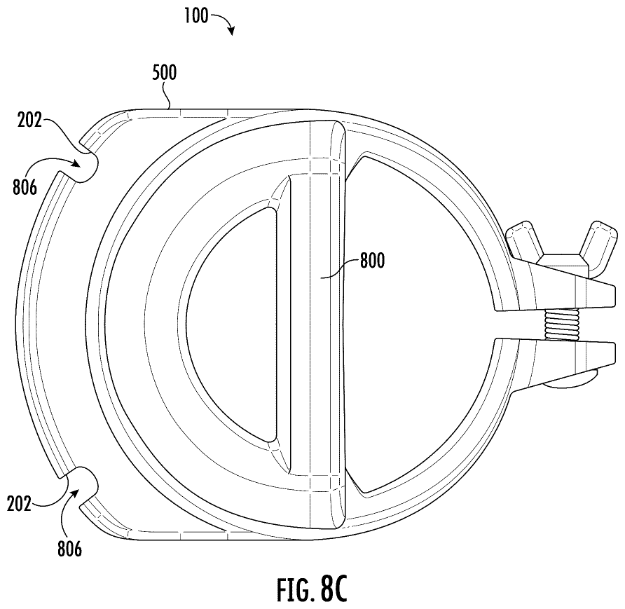

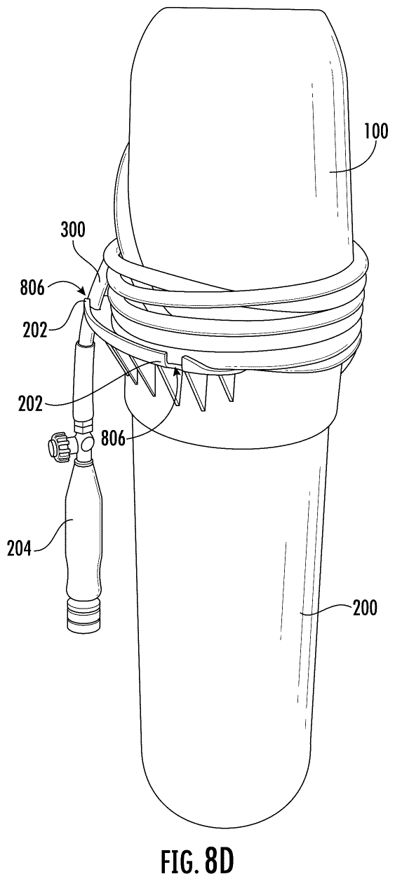

FIGS. 8A and 8B illustrate an alternate design for carry handle assembly 100. In FIGS. 8A and 8B, handle portion 106 is located at an end 802 of carry handle assembly 100, rather than in sidewall 111. In particular, second opening 110 formed by handle portion 106 and a handle 800 are located at end 802 of carry handle assembly 100, which is opposite end 804 of carry handle assembly 100 adjacent to which friction clamp 104 is located. In FIGS. 8A and 8B, second opening 110 is semi-circular in shape, and handle 800 extends diametrically across end 802. When carry handle assembly 100 is secured to a pressurized gas cylinder, handle 800 is centered over the pressurized gas cylinder, which is more effective for lifting and carrying the pressurized gas cylinder than the example illustrated in FIG. 1 in which second opening 110 is located in sidewall 111.

Another feature of the design illustrated in FIGS. 8A and 8B is that hose shelf 500 forms an acute angle α with respect to sidewall 111 of carry handle assembly 100. The acute angle formed by hose shelf 500 facilitates holding a gas hose in place against the sidewall of carry handle assembly 100. Hose shelf 500 also includes a pair of notches 806, each of which forms a torch holder 202. In FIG. 8C, it can be seen that notches 806 that for torch holders 202 are circumferentially spaced from each other so that a gas hose 300 is wound around carry handle assembly 100, the end of gas hose 300 that holds torch 204 will fit in one of notches 806 without an excessive amount of gas hose 300 being below hose shelf 500. FIG. 8D illustrates gas hose 300 extending through one of torch holders 202 such that torch 204 hangs below hose shelf 500 without an excessive amount of gas hose 300 being below hose shelf 500

Another feature of the design illustrated in FIGS. 8A and 8B is that bolt 502 is a carriage bolt, and aperture 116 includes a square profile for receiving the square-profiled portion on the underside of the head of bolt 502. Using a carriage bolt, rather than a hex bolt, enables friction clamp 104 to be tightened manually without a wrench or other tool to keep the bolt head from rotating.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A carry handle assembly for a pressurized gas cylinder, the carry handle assembly comprising:
a cylinder-attaching portion for encircling and attaching to an outer sidewall of a pressurized gas cylinder;
a friction clamp located on the cylinder-attaching portion for securing the cylinder-attaching portion to the pressurized gas cylinder; and
a handle portion including a handle for lifting and carrying the pressurized gas cylinder.

2. The carry handle assembly of claim 1 wherein the cylinder-attaching portion is adjustable in diameter using the friction clamp to securely attach to pressurized gas cylinders of different sizes.

3. The carry handle assembly of claim 1 wherein the friction clamp comprises a bolt clamp.

4. The carry handle assembly of claim 3 wherein the bolt clamp includes first and second tabs extending radially outward from the cylinder-attaching portion, each of the first and second tabs including an aperture for receiving a bolt.

5. The carry handle assembly of claim 4 wherein the first and second tabs are circumferentially spaced from each other by a distance that causes a diameter of the cylinder-attaching portion to exceed a diameter of the pressurized gas cylinder.

6. The carry handle assembly of claim 5 comprising a bolt insertable through the apertures and a corresponding nut for threaded attachment to the bolt to decrease the distance between the first and second tabs and tighten the cylinder-attaching portion around an outer circumference of the pressurized gas cylinder.

7. The carry handle assembly of claim 1 comprising a sidewall and a first opening in the sidewall for accessing a gas valve of the pressurized gas cylinder.

8. The carry handle assembly of claim 7 wherein the handle portion forms a second opening in the sidewall.

9. The carry handle assembly of claim 2 wherein the handle portion forms a second opening at an end of the carry handle assembly, and the handle extends diametrically across the end of the carry handle assembly.

10. The carry handle assembly of claim 1 comprising a torch holder for holding a torch fed by gas from the pressurized gas cylinder.

11. The carry handle assembly of claim 10 wherein the torch holder extends radially outward from the handle portion.

12. The carry handle assembly of claim 10 comprising a hose shelf for holding a gas hose, wherein the torch holder comprises a notch formed by the hose shelf.

13. The carry handle assembly of claim 12 comprising a sidewall and wherein the hose shelf forms an acute angle with respect to the sidewall.

14. The carry handle assembly of claim 1 wherein the cylinder-attaching portion and the handle portion comprise a polypropylene material.

15. A method for lifting and carrying a pressurized gas cylinder, the method comprising:
placing a cylinder-attaching portion of a carry handle assembly around an outer sidewall of a pressurized gas cylinder;
tightening a friction clamp extending from the cylinder-attaching portion for securing the cylinder-attaching portion to the pressurized gas cylinder; and
lifting the pressurized gas cylinder via a handle portion of the carry handle assembly by gripping a handle formed in the handle portion and exerting upward force on the handle to lift the pressurized gas cylinder.

16. The method of claim 15 wherein tightening the friction clamp includes inserting a bolt through apertures in first and second tabs of the friction clamp, threading a nut onto the bolt, and tightening the nut to decrease a diameter of the cylinder-attaching portion.

17. The method of claim 15 comprising inserting gas hose attached to the pressurized gas cylinder into a torch holder formed in the carry handle assembly.

18. The method of claim 15 comprising winding a gas hose attached to the pressurized gas cylinder around carry handle assembly and resting turns of the gas hose on a hose shelf extending radially outward from a sidewall of the carry handle assembly.

19. The method of claim 18 comprising inserting the gas hose through a torch holder extending radially outward from the carry handle assembly.

20. The method of claim 18 comprising inserting the gas hose through a torch holder comprising a notch formed by the hose shelf.
